(19) United States
(12) Patent Application Publication
(10) Pub. No.: US 2026/0138848 A1
(43) Pub. Date: May 21, 2026

(54) METHOD FOR REPOSITIONING AN ELEVATOR CAR BY USING AN EDGE DEVICE

(71) Applicant: Inventio AG, Hergiswil (CH)

(72) Inventor: Claudio Colombano, Beckenried (CH)

(21) Appl. No.: 19/113,447

(22) PCT Filed: Sep. 6, 2023
(86) PCT No.: PCT/EP2023/074364

§ 371 Date: Mar. 20, 2025

(30) Foreign Application Priority Data
Sep. 28, 2022 (EP) 22198225.9

(51) Int. Cl. B66B 1/34; B66B 1/06

(52) U.S. Cl. CPC B66B 1/3492; B66B 1/06; B66B 1/3461

(57) ABSTRACT

A method for repositioning an elevator car of an elevator installation uses an edge device. An elevator installation including the elevator car is connected with the edge device. A controller of the elevator installation informs the edge device of the actual position of the elevator car by sending a message or signal from the controller to the edge device. The edge device saves the actual position of the elevator car as position data in a memory of the edge device and then sends the position data to the controller when the controller asks the edge device for the actual position of the elevator car.

### FIELD

The present invention relates to a method for repositioning an elevator car of an elevator installation by using an edge device. The invention also relates to an elevator installation connected with such an edge device that an elevator car of the elevator installation can be repositioned. The invention further relates a computer program product and a computer-readable medium comprising such a computer program product.

### BACKGROUND

Elevators are used to transport people or goods between different floors or height-levels of a building or structure. Before an elevator is put into operation, it is usually necessary to set the respective stopping positions of an elevator car at the individual floors via an elevator controller so that the elevator car will reach every floor correctly.

In order to allocate correct floor numbers to the respective floors or to position an elevator car correctly on a floor, a technician usually travels with the elevator car from floor to floor and measures the car positions in a shaft and manually inputs the landing positions/floors into an elevator controller. Sometimes it needs to reset the elevator controller or even the whole elevator system in the event of a failure, a malfunction detected at the elevator installation, wherein this reset normally is initiated spontaneously by the elevator installation itself. The reset can be a power-on-reset (POR) or a brown-out-reset (BOR). However, the controller generally cannot automatically determine/detect where the elevator car is after the reset. Thus, the elevator car must move at first to a predefined floor—usually the ground floor—in order to configure the position of the elevator car on the ground floor. This process is called a synchronization trip. Depending on the position of the car at the moment of the resetting and the height of the shaft, the synchronization trip of the car could take considerable amount of time. Even though a spontaneous reset of a controller is very rare, they cannot be excluded in principle on account of software bugs, CPU congestion, or other issues. On the other hand, if a passenger happens to be in the elevator car at the moment of the reset, such a synchronization trip is uncomfortable to this passenger as he/she might feel trapped.

In the past, such resets were mainly caused by a power-down of an elevator installation. To avoid a reset, nowadays, an elevator installation often possesses a UPS-system (Uninterruptible Power Supply) that provides for automatic evacuation in case of main power failure. The UPS-System may keep a controller power-on at all times to prevent a reset when power returns. Alternatively, another classical solution is to store any update about the position into a non-volatile memory like a ROM (Read-only memory), a static RAM (Random-access memory), or a flash, etc. This kind of memory whose state is not affected by a reset, but it is very costly, and frequent updates to a flash memory might shorten its lifespan considerably. Sometimes an elevator provides a memory file system that allows a range of dynamic memory to preserve its state after a reset. However, this solution is usually unreliable as it may not provide a necessary adequate support to ensure the data integrity.

Therefore, when an elevator controller is reset, there may be a need for a method to overcome the aforementioned disadvantages. This method should be performed in a simplified, faster, more cost-effective way, and/or with a reduced risk of errors. Furthermore, there may also be a need for an elevator installation that is capable of being operated by the method, as well as a computer program product configured to carry out the method and a computer-readable medium provided with the product.

### SUMMARY

A need of this kind can be satisfied by the subject matter according to any of the advantageous embodiments defined in the following description.

A first aspect of the invention relates to a method for repositioning an elevator car of an elevator installation, wherein the elevator installation comprises a controller connected with an edge device, which edge device is arranged between the elevator installation and a network. The controller could be a main controller or a sub controller of the elevator installation. The controller may inform the edge device of the actual position of the elevator car. For this purpose, a message or signal can be sent from the controller to the edge device for notifying the actual position of the elevator car. This notification, for example, can be submitted continually or periodically at regular intervals. The edge device may save the actual position of the elevator car as position data in a memory of the edge device and then send the position data to the controller when the controller asks the edge device for the actual position of the elevator car.

An edge device, as a network component, is usually responsible for connecting the elevator installation to a local area network (LAN) or an external wide area network (WAN), which is wired or wirelessly connected with the elevator installation, so that the edge device may serve as an entry point to a network for an elevator installation. The edge device includes integrated access devices (IADs), such as routers, switches, wide-area networks (WANs), firewalls, computers, or mobile phones, etc. The network can be a local network, an external network, or a public network.

According to an embodiment in respect of the first aspect of the present invention, the actual position is determined in relation to one floor or two adjacent floors. Depending on when the reset is performed, the elevator car can be stopped at any position in the shaft, but it is not necessary to accurately determine the absolute position of the elevator car. In order to start or continue the interrupted trip of the elevator car, it only needs to know on which floor the elevator car is at present, or at which floor it will arrive next.

According to an embodiment in respect of the first aspect of the present invention, the actual position is detected by a multiple of thresholds (or flags) arranged longitudinally in a shaft of the elevator installation, wherein every threshold is assigned to one of the floors along the shaft. The threshold information can encode a floor number, such as “the first floor”, “the second floor”, “the third floor” . . . and so forth. This allows a control information to be automatically assigned to a particular floor. The threshold can be defined by different types of sensors, such as RFIDs (Radio-frequency identification) or NFC (near-field communication).

According to an embodiment in respect of the first aspect of the present invention, the controller will ask the edge device for the actual position of the elevator car when the controller or an operation of the elevator installation has been reset or rebooted, or when the controller has lost the position of the elevator car. A controller usually requires a working memory (e.g., RAM), so that the data can be kept in mind while performing a task. However, such data, e.g., the actual position of the elevator car, could be lost when the controller is reset/rebooted during performing a task. In this case, when the controller asks the edge device which saved the data before the reset/restart, the controller may have an opportunity to get the lost data again. Furthermore, the controller may register the position of the elevator car based on receiving the position data from the edge device so that the controller may reposition the elevator car after the reset/reboot.

According to an embodiment in respect of the first aspect of the present invention, after the resetting or the rebooting, the elevator car travels to a next lower or higher floor with the help of the thresholds, and the controller allocates a floor number to the next floor based on the position data received from the edge device.

According to an embodiment in respect of the first aspect of the present invention, the elevator car performs a synchronization trip for allocating floor numbers to other floors. Then, all floors will have their correct floor number.

Embodiments of the described method can advantageously be carried out using an elevator installation according to an embodiment of the second aspect of the invention.

A second aspect of the invention relates to an elevator installation which comprises an elevator car and a controller. The elevator car can move vertically in a shaft of the elevator installation, and the controller is connected with an edge device arranged between the elevator installation and a network in this manner that the controller can inform the edge device of the actual position of the elevator car, wherein when the operation of the controller of the elevator installation has been reset or restarted, and/or when the controller has lost the position of the elevator car, the controller can also ask the edge device for the actual position of the elevator car. The actual position, for example, can be determined in relation to one floor or two adjacent floors. And the network is for example a local network, an external network, or a public network.

According to an embodiment in respect of the second aspect of the present invention, the elevator installation comprises a multiple of thresholds arranged in the shaft, and each threshold is assigned to one floor along the shaft.

According to a further embodiment in respect of the second aspect of the present invention, after the resetting or the rebooting, the elevator car may proceed to a next lower or higher floor with the help of the thresholds, and the controller is able to allocate a floor number to the next floor based on the position data received from the edge device. Therefore, the elevator car can be also repositioned by this way.

According to a further embodiment in respect of the second aspect of the present invention, the elevator car may perform a synchronization trip for allocating floor numbers to other floors.

A third aspect of the invention relates to a computer program product with computer-readable instructions, which, when executed on a computer-controlled device, instruct the device to carry out a method according to an embodiment of the first aspect of the invention. In other words, such a computer program product can be viewed as the application by means of which a computer-controlled device is programmed in order to be able to carry out its task in the described method. The computer program product can be programmed in any computer language.

A fourth aspect of the invention relates to a non-transitory computer-readable medium on which a computer program product according to an embodiment of the third aspect of the invention is stored. For example, the computer program product can be stored on a portable computer-readable medium, such as a flash memory, a CD, a DVD, etc. Alternatively, the computer program product can be stored on a permanently installed computer or server and downloaded therefrom, for example, via a network such as the Internet. In particular, the computer program product can be stored on computers that are part of a cloud.

Possible features and advantages of embodiments of the invention can be considered, inter alia and without limiting the invention, to be based upon the concepts and findings described below. A person skilled in the art will recognize that the features may be combined, adapted or replaced as appropriate in order to arrive at further embodiments of the invention.

### DESCRIPTION OF THE DRAWINGS

FIG. 1 shows an elevator installation operated by a method according to one embodiment of the invention.

FIG. 2 shows a flowchart for a method according to one embodiment of the invention.

The drawings are merely schematic and not to scale.

### DETAILED DESCRIPTION

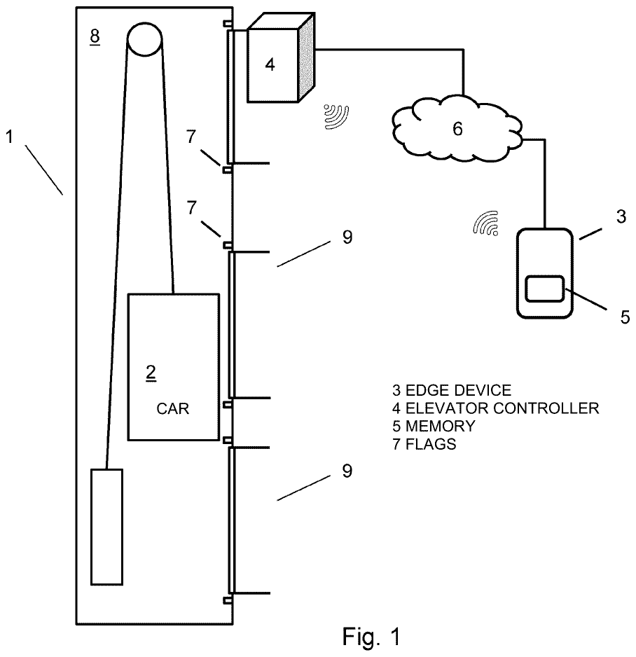

FIG. 1 shows an elevator installation 1 that comprises an elevator car 2 which can move in an elevator shaft 8 and stop at different floors 9. An elevator controller 4 is provided, which can also be as a so-called main controller of the elevator installation 1 responsible for coordinating all aspects of elevator operating. The controller 4 is wired or wirelessly connected with an edge device 3 provided between the elevator installation 1 and a network 6. The network 6 is, for example, a local network, an external network, or a public network.

A multiple of flags as thresholds 7 are longitudinally arranged in the shaft 8, wherein every threshold 7 is assigned to one of the floors 9 along the shaft 8. The threshold 7 can be defined, for example, by RFIDs.

During operation of the elevator installation 1, the controller 4 informs the edge device 3 of the actual position of the elevator car 2. For example, a message or signal can be sent from the controller 4 to the edge device 3 continually or periodically to inform the edge device 3 of the actual position of the elevator car 2. The actual position of the elevator car 2 can be detected by the thresholds 7 and determined relative to one floor or two adjacent floors 9. This means that when the elevator car 2 is located between two adjacent floors, it is not necessary to know the exact position of the elevator car 2. The controller 4 may only inform the edge device 3 of a position between two adjacent floors.

The edge device 3 will save this actual position of the elevator car in its memory 5 as position data. When the controller 4 or an operation of the elevator installation has been reset or rebooted, or when the controller has lost the position of the elevator car 2, the controller 4 will ask the edge device 3 for the actual position of the elevator car 2. In this case, the edge device 3 will send the position data back to the controller 4, so as to notify the controller 4 of the actual position of the elevator car 2. The controller 4 then registers the position of the elevator car based on receiving the position data from the edge device 3 so that the controller 4 may get the lost data again. After then, when the elevator car 2 reaches the next floor 9, the controller 4 may know exactly which floor this floor is.

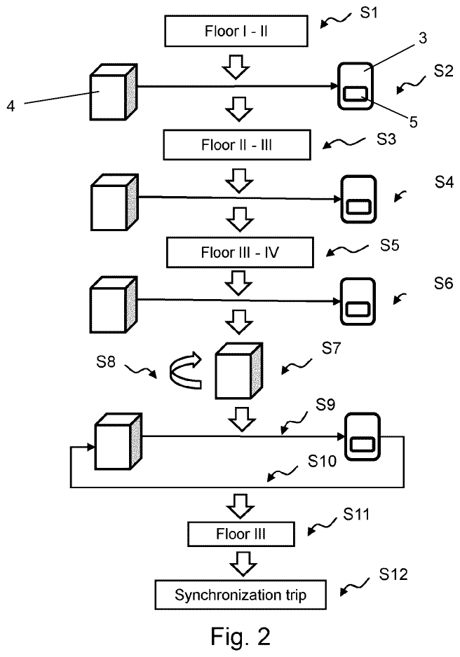

FIG. 2 shows a flowchart for a method according to one embodiment of the invention. The method can be carried out with the elevator installation 1 and an edge device 3 described with reference to FIG. 1.

According to this method, a typical event sequence is represented by the following steps: an elevator car 2 is travelling from the first floor (floor-I) to the fifth floor (floor-V). A controller 4 of the elevator installation 1 does not need to know the position of the car 2 exactly, so that only the position between two adjacent floors is communicated between elevator installation 1 and the edge device 3.
S1: the car 2 leaves floor-I upwards,
S2: the controller 4 sends information to an edge device 3 that the car 2 is between floor-1 and floor-II, and the edge device 3 saves the position of the car 2 in a memory unit 5 of the edge device 3,
S3: the car 2 leaves the floor-II further upwards,
S4: the controller 4 informs the edge device 3 that the car 2 now is between floor-II and floor-III, and the edge device 3 saves the position of the car 2 in a memory unit 5 of the edge device 3,
S5: the car 2 leaves floor-III further upwards,
S6: the controller 4 informs the edge device 3 that the car 2 is now located between floor-III and floor-IV, and the edge device 3 saves the position of the car 2 in a memory unit 5 of the edge device 3,
S7: the controller 4 resets itself,
S8: the controller 4 boots itself up to resume or continue the operation of the elevator installation 1,
S9: the controller 4 asks edge device 3 for the latest position of the car 2, because at this moment the controller 4 no longer knows where the car 2 is,
S10: the edge device 3 notifies the controller 4 that the car 2 was between floor-III and floor-IV,
S11: the elevator car 2 moves to, for example, the next lower floor with the help of the thresholds 7 so that the controller 4 knows this floor is floor-III and allocates floor number “III” to this floor, and
S12: the elevator car 2 performs a synchronization trip through other floors, and the controller 4 allocates the correct floor numbers to the floors accordingly.

Through the above process, when the elevator installation 1 after resetting/rebooting resumes operation again, the elevator installation 1 or its controller 4 may recognize which floor or between which two floors 9 the elevator car 2 is currently on, and then the identification of all floors 9 can be completed after the elevator car 2 travels through all other floors 9.

Finally, it should be noted that terms such as “comprising,” “having,” etc. do not preclude other elements or steps, and terms such as “a” or “an” do not preclude a plurality. Furthermore, it should be noted that features or steps that have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method to reposition an elevator car in a shaft of an elevator installation, the elevator installation including a controller connected with an edge device, the edge device being arranged between the elevator installation and a network, the method comprising steps of:
the controller informing the edge device of an actual position of the elevator car in the shaft;
the edge device saving the actual position of the elevator car received from the controller as position data in a memory of the edge device; and
the edge device sending the saved position data from the memory to the controller in response to the controller asking the edge device for the actual position of the elevator car.

17. The method according to claim 16 including the controller determining the actual position of the elevator car in relation to one floor or in relation to two adjacent floors, the floors being along the shaft.

18. The method according to claim 16 including the controller detecting the actual position of the elevator car using multiple of thresholds arranged in the shaft wherein each of the thresholds is assigned to a different floor of plurality of floors along the shaft.

19. The method according to claim 16 including the controller asking the edge device for the actual position of the elevator car when the controller or an operation of the elevator installation has been reset or rebooted.

20. The method according to claim 16 including the controller asking the edge device for the actual position of the elevator car when the controller has lost the actual position of the elevator car.

21. The method according to claim 16 including, the controller detecting the actual position of the elevator car using multiple of thresholds arranged in the shaft wherein each of the thresholds is assigned to a different floor of plurality of floors along the shaft, and after a resetting or a rebooting of the controller or an operation of the elevator installation, the controller operates the elevator car to travel to a next one of the floors, either lower or higher, using the thresholds, and the controller allocates a floor number to the next floor based on the position data received from the edge device.

22. The method according to claim 21 wherein the controller operates the elevator car to perform a synchronization trip for allocating floor numbers to ones of the floors other than the next floor.

23. A computer program product including computer-readable instructions that, when stored on a non-transitory computer-readable medium and executed by a computer-controlled device, instruct the device to carry out the method according to claim 16.

24. A non-transitory computer-readable medium on which the computer program product according to claim 23 is stored.

25. An elevator installation comprising:
an elevator car moveable in a shaft of the elevator installation;
a controller connected with an edge device, the edge device being arranged between the elevator installation and a network; and
wherein the controller is adapted to inform the edge device of an actual position of the elevator car in the shaft, to ask the edge device for the actual position of the elevator car when the controller or an operation of the elevator installation has been reset or rebooted and/or when the controller has lost the actual position of the elevator car.

26. The elevator installation according to claim 25 wherein the controller determines the actual position in relation to one floor or two adjacent floors, the floors being along the shaft.

27. The elevator installation according to claim 25 including multiple thresholds arranged along the shaft, each of the thresholds being assigned to an associated floor of a plurality of floors along the shaft.

28. The elevator installation according to claim 27 wherein the controller is adapted to, after the resetting or the rebooting, move the elevator car to a next floor using the thresholds, the next floor being a next lower one of the floors or next higher one of the floors, and the controller allocates a floor number to the next floor based on the actual position received from the edge device.

29. The elevator installation according to claim 28 wherein the controller is adapted to move the elevator car on a synchronization trip in the shaft to allocate floor numbers to other ones of the floors.

30. The elevator installation according to claim 25 wherein the network is a local network, an external network, or a public network.
